(19) United States
(12) Patent Application Publication
(10) Pub. No.: US 2019/0094446 A1
(43) Pub. Date: Mar. 28, 2019

(54) BACKLIGHT UNIT AND DISPLAY DEVICE

(71) Applicant: SAMSUNG DISPLAY CO., LTD., Yongin-si (KR)

(72) Inventors: Seulgi KIM, Seoul (KR); Yongkyu KANG, Hwaseong-si, Gyeonggi-do (KR); Sangchul BYUN, Anyang-si, Gyeonggi-do (KR); Kangwoo LEE, Seoul (KR)

(21) Appl. No.: 16/126,538

(22) Filed: Sep. 10, 2018

(30) Foreign Application Priority Data
Sep. 25, 2017 (KR) 10-2017-0123103

(51) Int. Cl. F21V 8/00

(52) U.S. Cl. CPC G02B 6/0036; G02B 6/0073; G02B 6/0038

(57) ABSTRACT

A backlight unit includes: a light source; and a light guide plate including: an upper surface facing a display panel, a lower surface opposing the upper surface, including: a prism pattern area provided in plurality, and a linear pattern area provided between prism pattern areas, and a light incident surface facing the light source. The prism pattern area includes a prism provided in plurality arranged along a first direction perpendicular to the light incident surface, the linear pattern area comprises a linear pattern provided in plurality arranged along a second direction parallel to the light incident surface, and within the prism pattern area, a length of each of the prisms extends in the second direction parallel to the light incident surface, and lengths of the prisms increase as a distance along the first direction from the light incident surface increases.

This application claims priority to Korean Patent Application No. 10-2017-0123103, filed on Sep. 25, 2017, and all the benefits accruing therefrom under 35 U.S.C. §119, the contents of which is incorporated by reference herein in its entirety.

### BACKGROUND

### 1. Field

Embodiments of the invention relate to a backlight unit and a display device. More particularly, embodiments of the invention relate to a backlight unit and a display device having relatively high luminous efficiency by improving light incident to a light guide plate from a light source that may otherwise leaks toward a side surface of the light guide plate without being emitted perpendicularly from the light guide plate and/or to a display panel of the display device.

### 2. Description of the Related Art

Liquid crystal display (“LCD”) devices are a type of flat panel display (“FPD”) devices which have found wide application thereof. The LCD device includes two substrates including field-generating electrodes, e.g., a pixel electrode and a common electrode, and a liquid crystal layer interposed therebetween. Upon applying voltage to the field-generating electrodes, liquid crystal molecules of the liquid crystal layer are rearranged such that an amount of transmitted light is controlled in the LCD device.

An LCD device, which is a passive display device, includes a display panel which displays images with light and a backlight unit (“BLU”) which generates light and provides the light to the display panel. Backlight units are classified into a direct type backlight unit, an edge type backlight unit and a corner type backlight unit according to the position of the light source.

Edge type backlight units are widely used since manufacturing thereof is relatively easy, weight is relatively light and power consumption thereof is relatively low power as compared to direct type backlight units. In the case of the edge type backlight unit, a plurality of optical sheets for diffusing and collimating light provided from the light source may be disposed between a light guide plate and a display panel within the display device.

### SUMMARY

Embodiments of the invention may be directed to a backlight unit and a display device having relatively high luminous efficiency by reducing a light incident to a light guide plate from a light source that leaks toward a side surface of the light guide plate without being emitted perpendicularly therefrom such as towards a display panel.

According to an exemplary embodiment, a backlight unit includes: a light source which generates light used by a display panel to display an image; and a light guide plate which guides the light from the light source towards the display panel, the light guide plate including: an upper surface facing the display panel, a lower surface opposing the upper surface, including: a prism pattern area provided in plurality, and a linear pattern area provided between prism pattern areas, and a light incident surface facing the light source. The prism pattern area includes a prism provided in plurality arranged along a first direction perpendicular to the light incident surface, the linear pattern area includes a linear pattern provided in plurality arranged along a second direction parallel to the light incident surface, and within the prism pattern area, a length of each of the prisms extends in the second direction parallel to the light incident surface, and lengths of the prisms increase as a distance along the first direction from the light incident surface increases.

Each of the linear patterns may have at least one of triangular, semicircular, semi-elliptical, circular and trapezoidal cross-sectional shape.

Each of the linear patterns may have at least one of an embossed shape and a depressed engraved shape.

Each of the linear patterns may have a width in a range from about 5 micrometers (μm) to about 500 μm in the second direction.

The light guide plate may further include a body portion having a lower surface common to each of the prisms and the linear patterns. A first inclined surface of each of the linear pattern may have an angle in a range from about 1 degree to about 80 degrees with respect to the lower surface of the body portion.

The plurality of linear patterns may be disposed directly adjacent to and parallel to each other.

The plurality of linear patterns may be spaced apart from each other.

Linear patterns adjacent to each other may be arranged at an angle in a range from about 0 degrees to about 60 degrees with respect to each other.

Each the plurality of linear patterns may have a length extending in the first direction perpendicular to the light incident surface.

Lengths of the linear patterns may be substantially equal to each other.

The linear patterns may have different lengths from each other.

Lengths of the plurality of linear patterns may increase as a distance from a center portion of the linear pattern area decreases in the second direction.

Ends of each of the linear patterns may be aligned with the light incident surface.

The light guide plate may further include a light opposing surface opposing the light incident surface along the first direction perpendicular to the light incident surface. Each of the linear patterns may be aligned with the light opposing surface.

The plurality of prisms may be disposed directly adjacent to and parallel to each other in the second direction.

Each of the prisms may have at least one of an embossed shape and a depressed engraved shape.

The light guide plate may further include a body portion having a lower surface common to each of the prisms and the linear patterns. An angle between a first inclined surface of each of the prisms and the lower surface of the body portion may be substantially equal to an angle between a second inclined surface of each of the prisms and the lower surface of the body portion.

The upper surface of the light guide plate may include a plurality of lens patterns.

According to an exemplary embodiment, a display device includes: a display panel which displays an image with light; a light source which generates the light; and a light guide plate which guides the light from the light source towards the display panel, the light guide plate including: an upper surface facing the display panel, a lower surface opposing the upper surface, including: a prism pattern area provided in plurality, and a linear pattern area provided between prism pattern areas, and a light incident surface facing the light source. The prism pattern area includes a prism provided in plurality arranged along a first direction perpendicular to the light incident surface, the linear pattern area includes a linear pattern provided in plurality arranged along a second direction parallel to the light incident surface, within the prism pattern area, a length of each of the prisms extends in the second direction parallel to the light incident surface, and lengths of each of the prisms increase as a distance along the first direction from the light incident surface increases, within the linear pattern area between prism pattern areas, the plurality of linear patterns are spaced apart from each other along the second direction, and within a plane defined by the first and second directions, each of adjacent linear patterns spaced apart from each other is disposed inclined with respect to the light incident surface of the light guide plate.

With respect to the light incident surface of the light guide plate, a first linear pattern forms a first angle and a second linear pattern forms a second angle, the first linear pattern forming the first angle alternates in the second direction with the second linear pattern forming the second angle, and the first and second linear patterns form.

The foregoing is illustrative only and is not intended to be in any way limiting. In addition to the illustrative exemplary embodiments and features described above, further exemplary embodiments and features will become apparent by reference to the drawings and the following detailed description.

### BRIEF DESCRIPTION OF THE DRAWINGS

A more complete appreciation of the invention will become more apparent by describing in detail exemplary embodiments thereof with reference to the accompanying drawings, where:

FIG. 1 is an exploded perspective view illustrating an exemplary embodiment of a display device according to the invention;

FIG. 2 is a perspective view illustrating an exemplary embodiment of a light guide plate and a light source member of a display device according to the invention;

FIG. 3 is an enlarged perspective view illustrating area “A” of FIG. 2;

FIG. 4 is a perspective view illustrating another exemplary embodiment of a light guide plate and a light source member of a display device according to the invention;

FIG. 5 is an enlarged perspective view illustrating area “B” of FIG. 4;

FIG. 6 is an enlarged perspective view illustrating area “C” of FIG. 5;

FIG. 7 is a cross-sectional view taken along line I-I′ of FIG. 6;

FIGS. 8a and 8b are perspective views illustrating an exemplary embodiment of a plurality of prisms and a plurality of linear patterns arranged at a light guide plate according to the invention;

FIG. 9 is a perspective view illustrating another exemplary embodiment of a plurality of prisms and a plurality of linear patterns arranged at a light guide plate according to the invention;

FIG. 10 is a perspective view illustrating still another exemplary embodiment of a plurality of prisms and a plurality of linear patterns arranged at a light guide plate according to the invention;

FIG. 11 is a perspective view illustrating yet another exemplary embodiment of a plurality of prisms and a plurality of linear patterns arranged at a light guide plate according to the invention;

FIG. 12 is a perspective view illustrating yet another exemplary embodiment of a plurality of prisms and a plurality of linear patterns arranged at a light guide plate according to the invention; and

FIG. 13 is a perspective view illustrating yet another exemplary embodiment of a plurality of prisms and a plurality of linear patterns arranged at a light guide plate according to the invention.

### DETAILED DESCRIPTION

Exemplary embodiments will now be described more fully hereinafter with reference to the accompanying drawings. Although the invention may be modified in various manners and have several exemplary embodiments, exemplary embodiments are illustrated in the accompanying drawings and will be mainly described in the specification. However, the scope of the invention is not limited to the exemplary embodiments and should be construed as including all the changes, equivalents and substitutions included in the spirit and scope of the invention.

In the drawings, thicknesses of a plurality of layers and areas are illustrated in an enlarged manner for clarity and ease of description thereof. When a layer, area, or plate is referred to as being related to another element such as being “on” another layer, area, or plate, it may be directly on the other layer, area, or plate, or intervening layers, areas, or plates may be present therebetween. Conversely, when a layer, area, or plate is referred to as being related to another element such as being “directly on” another layer, area, or plate, intervening layers, areas, or plates may be absent therebetween. Further when a layer, area, or plate is referred to as being related to another element such as being “below” another layer, area, or plate, it may be directly below the other layer, area, or plate, or intervening layers, areas, or plates may be present therebetween. Conversely, when a layer, area, or plate is referred to as being related to another element such as being “directly below” another layer, area, or plate, intervening layers, areas, or plates may be absent therebetween.

The spatially relative terms “below,” “beneath,” “lower,” “above,” “upper” and the like, may be used herein for ease of description to describe the relations between one element or component and another element or component as illustrated in the drawings. It will be understood that the spatially relative terms are intended to encompass different orientations of the device in use or operation, in addition to the orientation depicted in the drawings. For example, in the case where a device illustrated in the drawing is turned over, the device positioned “below” or “beneath” another device may be placed “above” another device. Accordingly, the illustrative term “below” may include both the lower and upper positions. The device may also be oriented in the other direction and thus the spatially relative terms may be interpreted differently depending on the orientations.

Throughout the specification, when an element is referred to as being “connected” to another element, the element may be physically and/or electrically connected to the other element.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “At least one” is not to be construed as limiting “a” or “an.” “Or” means “and/or.” As used herein, the term “and/or” includes any and all combinations of one or more of the associated listed items. It will be further understood that the terms “comprises,” “including,” “includes” and/or “including,” when used in this specification, specify the presence of stated features, integers, steps, operations, elements and/or components, but do not preclude the presence or addition of one or more other features, integers, steps, operations, elements, components and/or groups thereof

It will be understood that, although the terms “first,” “second,” “third,” and the like may be used herein to describe various elements, these elements should not be limited by these terms. These terms are only used to distinguish one element from another element. Thus, “a first element” discussed below could be termed “a second element” or “a third element,” and “a second element” and “a third element” may be termed likewise without departing from the teachings herein.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ±30%, 20%, 10%, 5% of the stated value.

Unless otherwise defined, all terms used herein (including technical and scientific terms) have the same meaning as commonly understood by those skilled in the art to which this invention pertains. It will be further understood that terms, such as those defined in commonly used dictionaries, should be interpreted as having a meaning that is consistent with their meaning in the context of the relevant art and will not be interpreted in an ideal or excessively formal sense unless clearly defined in the present specification.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Some of the parts which are not associated with the description may not be provided in order to specifically describe embodiments of the invention and like reference numerals refer to like elements throughout the specification.

A passive display device includes a display panel which generates and displays images with light, and a backlight unit (“BLU”) which generates the light and provides the light to the display panel. A plurality of optical sheets for diffusing and collimating light provided from the light source may be disposed between a light guide plate of the backlight unit and a display panel of the display device.

In accordance with reducing a total thickness of the passive display device, omitting the plurality of optical sheets between the light guide plate and the display panel has been researched. As such an attempt, research has been carried out to arrange a pattern for perpendicularly emitting a light from a light source to be incident to the light guide plate. However, a portion of the light incident to the light guide plate from the light source undesirably leaks toward a side surface of the light guide plate without being emitted perpendicularly therefrom such as toward the display panel, and thus luminous efficiency is degraded.

In this specification, the display device is described as being a liquid crystal display (“LCD”) device. However, exemplary embodiments are not limited thereto, and any display device that receives light such as from a backlight unit and displays images with the received light may be included in the scope of the invention.

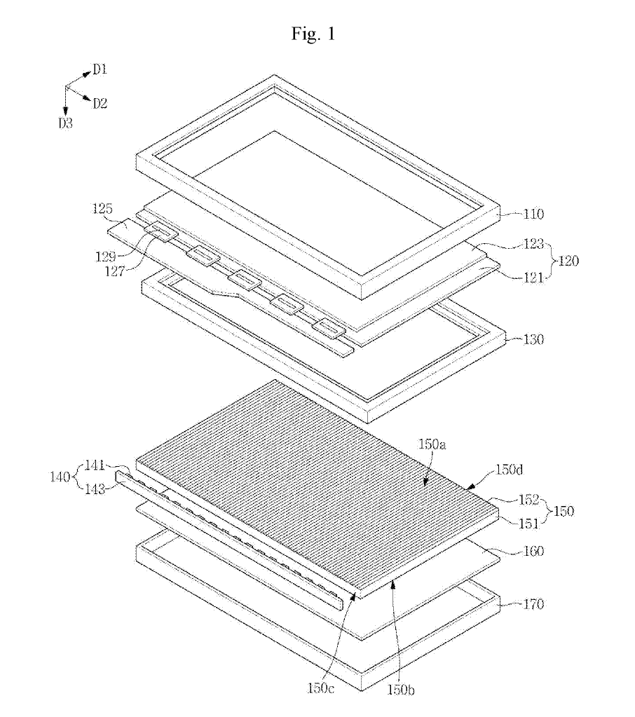

FIG. 1 is an exploded perspective view illustrating an exemplary embodiment of an LCD device according to the invention.

Referring to FIG. 1, a display device according to an exemplary embodiment includes an upper frame 110, a display panel 120, an intermediate frame 130, a light source (member) portion 140, a light guide plate 150, a reflection sheet 160 and a lower frame 170.

Hereinafter, the intermediate frame 130, the light source member 140, the light guide plate 150, the reflection sheet 160, the lower frame 170, or the like are collectively called a backlight unit. The backlight unit generates light and provides the light to the display panel 120 for displaying an image.

The upper frame 110 has an opening window for exposing an active area of the display panel 120 to outside the display device. The upper frame 110 is disposed so as to cover an edge of a front surface and a side surface of the display panel 120. The upper frame 110 may include a relatively rigid metal material such as stainless steel and/or a material having relatively good heat dissipation properties such as aluminum or an aluminum alloy.

The display panel 120 may be provided in a quadrangular plate shape. The display panel 120 may receive an electric signal and light from the outside thereof, and display images with the light. The display panel 120 may include a first (display) substrate 121, a second substrate 123 opposing the first substrate 121, an light controlling layer such as a liquid crystal layer (not illustrated) between the first substrate 121 and the second substrate 123, or the like.

The first substrate 121 includes therein a pixel electrode provided in plurality arranged in a matrix, a switching element such as a thin film transistor with which a driving voltage is applied to each of the pixel electrodes and various (conductive) signal lines through which control, driving and/or power signals are applied for driving the pixel electrodes and the thin film transistor to display an image. These elements may be disposed on a base substrate within the first substrate 121.

The second substrate 123 is disposed to oppose the first substrate 121, and includes a common electrode including a transparent conductive material, and a color filter. The color filter may include red, green and blue color filters. These elements may be disposed on a base substrate within the second substrate 123.

The liquid crystal layer (not illustrated) is interposed between the first substrate 121 and the second substrate 123, and orientations of a material thereof are rearranged by an electric field formed between the pixel electrode and the common electrode. As such, the rearranged liquid crystal layer adjusts a transmittance of a light emitted from the backlight unit and passed through the display panel 120, such that the adjusted light passes through the color filter of the display panel 120 to display images to the outside of the display device at a viewing side thereof

In addition, a lower polarization plate (not illustrated) may be further disposed on a back surface of the first substrate 121 and an upper polarization plate (not illustrated) may be further disposed on an upper surface of the second substrate 123. The upper polarization plate and the lower polarization plate may have a planar area corresponding to a planar area of the display panel 120.

The upper polarization plate may transmit therethrough only a specific polarized light among light arriving from the outside, and absorb or block the remaining light. The lower polarization plate may transmit therethrough only a specific polarized light among the light emitted from the backlight unit, and absorb or block the remaining light.

A driving circuit board 125 may be disposed at a one or more side of the display panel 120. The driving circuit board 125 may apply various control signals and/or a power signal to the display panel 120 for driving the display panel 120 to display an image.

The display panel 120 and the driving circuit board 125 may be electrically connected to each other by at least one flexible printed circuit board (“FPCB”) 127. The FPCB 127 may be a chip on film (“COF”) or a tape carrier package (“TCP”). The number of the FPCBs 127 may vary depending on an overall size and/or driving scheme of the display panel 120.

A driving chip 129 may be mounted on the FPCB 127. The driving chip 129 may generate various driving signals for driving the display panel 120. The driving chip 129 may be expressed as a driver integrated circuit (“IC”) or a source IC in which a timing controller and a data driving circuit are integrated into a single chip.

The intermediate frame 130 may support an edge of a back surface of the display panel 120, and accommodate therein the light source member 140, the light guide plate 150, the reflection sheet 160, or the like.

The intermediate frame 130 may have an overall polygonal frame shape with an empty (receiving) space defined therein. In an exemplary embodiment, for example, the intermediate frame 130 may have a quadrangular frame shape with an empty (receiving) space defined therein. The intermediate frame 130 may be disposed or formed into a single indivisible shape, or may include a plurality of separate frame portions assembled with each other. The intermediate frame 130 may include a flexible material such as plastic. The intermediate frame 130 may be an injection-molded member such as formed through an injection molding process, for example.

The light source member 140 includes a light source 141 and a light source substrate 143 on which the light source 141 is disposed. The light source 141 may be provided in plural on the light source substrate 143.

The light source 141 may be disposed at a corner portion or at a side surface of the light guide plate 150. That is, the light source 141 may generates and emit a light toward the corner portion or the side surface of the light guide plate 150. The light source 141 may include at least one light emitting diode (“LED”) chip (not illustrated) and a package (not illustrated) which accommodates the LED chip therein. In an exemplary embodiment, for example, the LED chip (not illustrated) may be a gallium nitride (GaN)-based LED chip which generates and/or emits a blue light.

The number of the light sources 141 may vary in consideration of the overall size, luminance uniformity, or the like of the display panel 120. The light source substrate 143 may be a printed circuit board (“PCB”) or a metal printed circuit board (“metal PCB”).

The light source member 140 may be disposed at one side surface, at opposite side surfaces, or at all side surfaces of the light guide plate 150 in consideration of the overall size, luminance uniformity, or the like of the display panel 120. That is, the light source member 140 may be minimally disposed at corner portions of the light guide plate 150. Herein, the light source member 140 is assumed to be disposed at a side surface of the light guide plate 150.

Although not illustrated in FIG. 1, a wavelength conversion portion (not illustrated) may be disposed between the light source member 140 and the light guide plate 150. The wavelength conversion portion (not illustrated) may include a material that converts a wavelength of the light. In an exemplary embodiment, for example, the wavelength conversion portion may convert a wavelength of a blue light emitted from a blue LED light source into a white light.

The light guide plate 150 receives the light from the light source 141 and provides the light to the display panel 120. Although described as a plate such as having a relatively large cross-sectional thickness for ease of description for convenience of explanation, the light guide plate 150 may be in the form of a sheet or a film for which the cross-sectional thickness is smaller than that of the plate and is relatively small as compared to the planar size thereof, to reduce an overall thickness of the display device. That is, the light guide plate 150 may be understood as having concepts of a plate and a film for guiding light.

Hereinafter, for ease of description, one surface of the light guide plate 150 facing the display panel 120 is defined as an upper surface 150a, another surface of the light guide plate 150 opposing the upper surface 150a is defined as a lower surface 150b, another surface of the light guide plate 150 facing the light source member 140 is defined as a light incident (side) surface 150c, and another surface of the light guide plate 150 opposing the light incident surface 150c is defined as a light opposing (side) surface 150d. Light guided within the light guide plate 150 exits to outside the light guide plate 150 through the upper surface 150a thereof. Side surfaces of the light guide plate 150 each connect the upper surface 150a and the lower surface 150b to each other. The light incident surface 150c and the light opposing surface 150d are defined among the side surfaces of the light guide plate 150 which connect the upper and lower surfaces 150a and 150b to each other.

In addition, for ease of descriptions, a direction perpendicular to the light incident surface 150c is defined as a first direction D1, a length direction in which the light incident surface 150c extends is defined as a second direction D2 which crosses the first direction D1, and a thickness direction of the light guide plate 150 is defined along a third direction D3. The display device and components thereof may be disposed in a plane defined by the first and second directions D1 and D2. A thickness of the display device and components thereof is taken along the third direction D3.

The light guide plate 150 according to an exemplary embodiment may include a body portion 151 and a lens pattern 152 provided in plurality on the body portion 151. The body portion 151 may be considered as common to each of the lens patterns 152, where the lens patterns 152 each extend from the body portion 151.

The body portion 151 may include a material having light transmitting characteristics, such as an acrylic resin, e.g., polymethylmethacrylate (“PMMA”), polycarbonate, or a tempered glass, so as to guide the light efficiently.

The plurality of lens patterns 152 disposed on the body portion 151 may include a relatively hard coating such as resin, and the resin may be ultraviolet (“UV”) cured to have properties similar to those of polycarbonate. The resin may include an oligomer, a monomer, a photoinitiator, silicone, or the like, and may be classified into a relatively soft resin and a relatively hard resin depending on a content of the silicon and monomer within the resin.

Descriptions of the shape of the plurality of lens patterns 152 disposed on the body portion 151 will be described in detail below.

The reflection sheet 160 may include, for example, polyethylene terephthalate (“PET”), and have reflecting characteristics. A surface of a main body of the reflective sheet 160 may be coated with a diffusion layer including, for example, titanium dioxide to have a reflecting characteristic. In addition, a main body of the reflection sheet 160 may include a material including a metal such as silver (Ag) to have a reflecting characteristic.

The lower frame 170 may include a metal material having relatively high rigidity and excellent heat dissipation characteristics. In an exemplary embodiment, for example, the lower frame 170 may include at least one selected from stainless steel, aluminum, an aluminum alloy, magnesium, a magnesium alloy, copper, a copper alloy, and an electrogalvanized steel sheet.

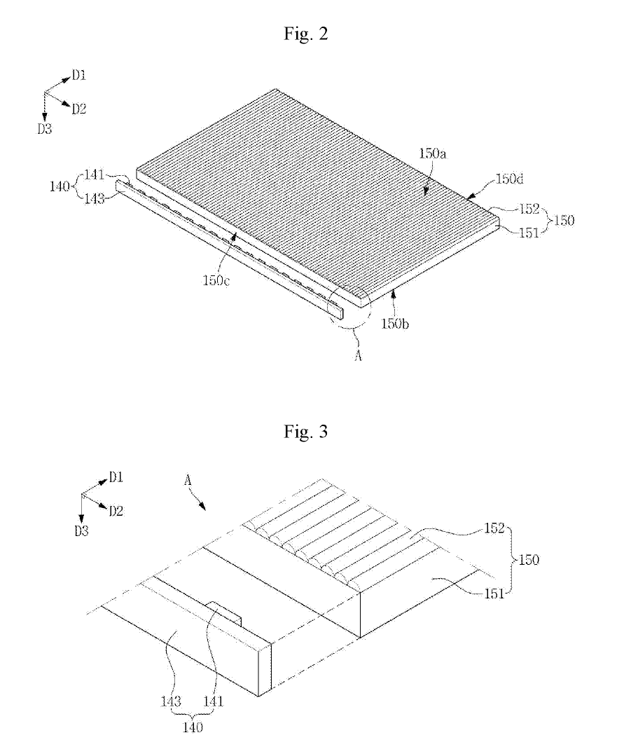

FIG. 2 is a perspective view illustrating an exemplary embodiment of a light guide plate and a light source member of a display device according to the invention, and FIG. 3 is an enlarged perspective view illustrating area “A” of FIG. 2. In detail, FIGS. 2 and 3 are perspective views respectively illustrating the upper surface 150a and the light incident surface 150c of the light guide plate 150 according to an exemplary embodiment.

Referring to FIGS. 2 and 3, the light guide plate 150 according to an exemplary embodiment may include the lens pattern 152 disposed on or at the upper surface 150a. The lens pattern 152 may be provided in plurality to include a plurality of lenses each lengthwise extending in the first direction D1 and arranged along the second direction D2. A width of the lens pattern 152 is defined in a direction perpendicular to the length direction thereof, e.g., a width direction in the second direction D2. In an alternative exemplary embodiment, the lens pattern 152 may be provided in plurality to include a plurality of lenses lengthwise extending in the second direction D2 and arranged along the first direction D1.

Each lens pattern 152 may have a semicircular or semi-elliptical cross-section, but exemplary embodiments are not limited thereto. Each lens pattern 152 may have a circular or triangular cross-section, and respective cross-sectional areas of the plurality of lenses may be different from each other.

Although FIGS. 2 and 3 show that the lens patterns 152 disposed adjacent to each other in the second direction D2 are arranged successively (e.g., no space therebetween along the second direction D2), exemplary embodiments are not limited thereto. The plurality of lens patterns 152 may be spaced apart from each other by a predetermined distance in the second direction D2.

The lens pattern 152 at an upper surface of the body portion 151 may define a portion or an entirety of the upper surface 150a of the light guide plate 150. In an exemplary embodiment, the upper surface 150a of the light guide plate 150 may be defined by only lens patterns 152, such that the upper surface of the body portion 151 does not define a portion of the overall upper surface 150a. Where the lens patterns 152 are spaced apart from each other, a portion of a surface of the body portion 151 (e.g., a flat surface or the upper surface thereof) may define a portion of the upper surface 150a of the light guide plate 150, while the lens patterns 152 define another portion of the upper surface 150a. However, the invention is not limited thereto.

The light guide plate 150 according to one or more exemplary embodiment may include the lens pattern 152 at the upper surface 150a thereof to collimate the light emitted through and/or from the light guide plate 150, such that the light guide plate 150 having the lens patterns 152 at the upper surface 150a thereof being viewable from outside the display device may be substantially prevented.

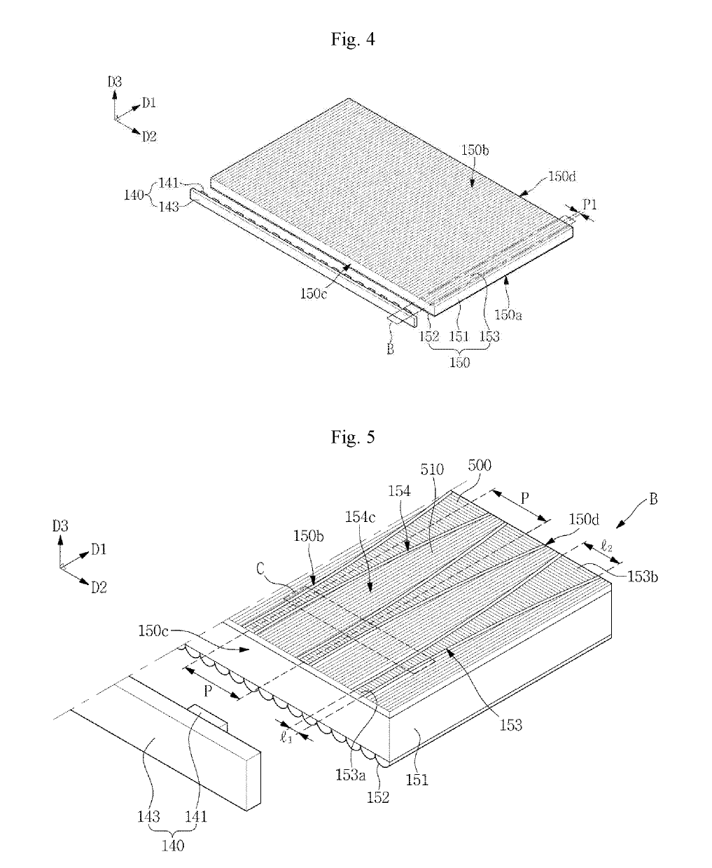

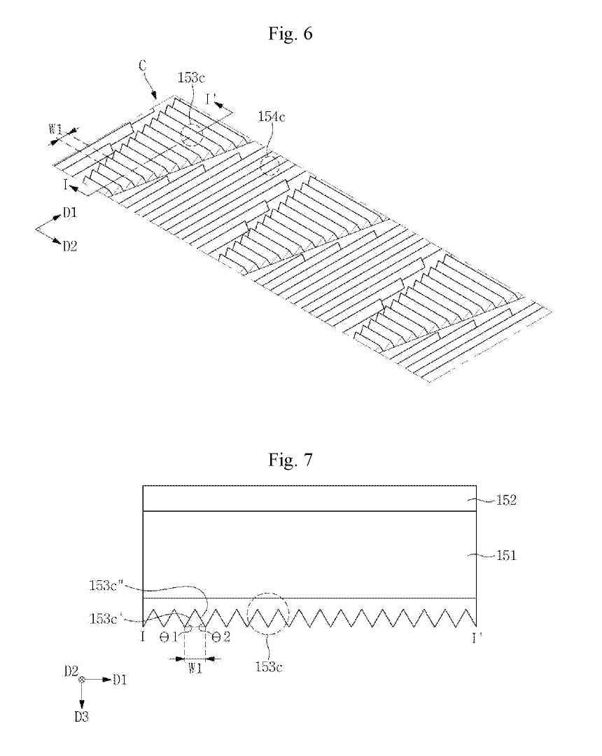

FIG. 4 is a perspective view illustrating another exemplary embodiment of a light guide plate and a light source member according to the invention, FIG. 5 is an enlarged perspective view illustrating area “B” of FIG. 4, FIG. 6 is a partial enlarged view illustrating area “C” of FIG. 5, and FIG. 7 is a cross-sectional view taken along line I-I′ of FIG. 6. FIGS. 4 and 5 are perspective views illustrating the lower surface 150b and the light incident surface 150c of the light guide plate 150 according to an exemplary embodiment.

Referring to FIGS. 4, 5 and 6, the light guide plate 150 according to an exemplary embodiment includes a prism pattern area 500 provided in plural at the lower surface 150b and a linear pattern area 510 which is between adjacent prism pattern areas 500.

In addition, the light guide plate 150 includes a prism pattern 153 at the prism pattern area 500 and a linear pattern 154 at the linear pattern area 510. The body portion 151 may be considered as common to each of the prism pattern 153 and the linear pattern 154, as each extend from the body portion 151.

A single prism pattern 153 includes a plurality of prisms 153a and 153b arranged along the first direction D1 which is perpendicular to the light incident surface 150c. Plural prisms patterns 153 are arranged along the second direction D2 which is parallel to the light incident surface 150c. That is, the plurality of prisms 153a and 153b which define a plurality of prism patterns 153 are arranged along both the first and second directions D1 and D2. A collection of the plurality of prisms 153a and 153b are disposed at the collective prism pattern area 500 and serve to reflect light incident to the plurality of prisms 153a and 153b from the light source 141 and to emit the light perpendicularly with respect to a light exit surface of the light guide plate 150 and the display panel 120.

A single linear pattern 154 includes a plurality of linear patterns 154c arranged along the second direction D2 parallel to the light incident surface 150c. Plural linear patterns 154 are arranged along the second direction D2. In an exemplary embodiment, a linear pattern 154 is disposed adjacent to side surfaces of the light guide plate 150, such as at outer edges thereof in the second direction D2, such that the linear pattern area 510 is an outermost area of the lower surface 150b along the second direction D2. A collection of the plurality of linear patterns 154c are disposed at the collective linear pattern area 510 and serve to reflect light refracted by the plurality of prisms 153a and 153b and leaked toward a side surface of the light guide plate 150 to be emitted perpendicularly with respect to a light exit surface of the light guide plate 150 and the display panel 120. In addition, the plurality of linear patterns 154c may be disposed at the linear pattern area 510 and serve to reflect light incident to the plurality of linear patterns 154c from the light source 141 and to emit the light perpendicularly with respect to a light exit surface of the light guide plate 150 and the display panel 120. The LCD device according to one or more exemplary embodiment may improve luminance, illuminance, and luminous efficiency by improving the side leakage of light with the linear pattern area 510.

The plurality of linear patterns 154c at the linear pattern area 510 may have various positions, quantities, lengths, angles and shapes. The details of the shape of the plurality of linear patterns 154c will be described below.

The linear patterns 154c may define a portion of the lower surface 150b of the overall light guide plate 150, much like the lens pattern 152 may define a portion of or an entirety of the upper surface 150a of the light guide plate 150, without being limited thereto. A portion of the lower surface of the body portion 151 may also define a portion of the lower surface 150b of the light guide plate 150, along with the prisms 153a through 153b and the linear patterns 154c. The portion of the lower surface 150b defined by the body portion 151 may be a flat portion at which no prism 153a through 153b or linear pattern 154c is defined embossed or engraved.

Referring to FIGS. 4 and 5, each of the prisms 153a and 153b may have a length extending in the second direction D2 parallel to the light incident surface 150c and each of the linear patterns 154c may have a length extending in the first direction D1 perpendicular to the first direction D1.

The plurality of prisms 153a and 153b arranged along the first direction D1 within a single prism pattern area 500 may have lengths in a range from about 5 micrometers (μm) to about 300 μm.

A length of the plurality of prisms 153a and 153b arranged along the first direction D1 within a single prims pattern area 500 may gradually increase in a direction from the light incident surface 150c toward the light opposing surface 150d. That is, a length l₁ of the prism 153a disposed most adjacent to the light incident surface 150c may be the smallest, and a length l₂ of the prism 153b disposed most adjacent to the light opposing surface 150d may be the largest. By arranging the plurality of prisms 153a and 153b to have increasing lengths in a direction from the light incident surface 150c to the light opposing surface 150d, a light emitted from the light guide plate 150 may be uniformly provided to the display panel 120.

In detail, the light provided from the light source member 140 becomes weaker as a distance from the light incident surface 150c increases, e.g., toward the light opposing surface 150d. Accordingly, in order to uniformly supply the light to the display panel 120, an amount of light reflected through the prism 153a disposed closest to the light incident surface 150c should be reduced, and an amount of light reflected through the prism 153a disposed closest to the light opposing surface 150d should be increased. According to one or more exemplary embodiment, as the prism 153a disposed closest to the light incident surface 150c has the smallest length within a single prims pattern area 500 and the lengths of the prisms increase in a direction toward the light opposing surface 150d, light may be uniformly provided to the display panel 120 from the light guide plate 150.

Since the lengths of the prisms disposed close to the light incident surface 150c are relatively small, in order to secure the uniformity, while the length of the light source 141 is relatively large, a large amount of side leakage light may be generated at a light incident portion of the light guide plate 150. That is, a portion of light incident to the plurality of prisms 153a and 153b from the light source 141 may be refracted and leaked to the side surface of the light guide plate 150, without being reflected by the plurality of prisms 153a and 153b and emitted perpendicularly as described above.

In addition, a portion of the light emitted from the light source 141 may not be incident to the plurality of prisms 153a and 153b but may be incident to an area where the plurality of prisms 153a and 153b are absent, thus failing to be emitted perpendicularly from the light guide plate 150 as described above. Accordingly, in one or more exemplary embodiment, in order to re-emit the side leakage light perpendicularly, the linear pattern 154 is disposed at the linear pattern area 510, in addition to disposing the prism pattern 153 at the prism pattern area 500, thereby improving the side leakage light and increasing the luminance, the illuminance and the luminous efficiency of the backlight unit and the display device.

The prisms 153a and 153b arranged along the second direction D2 which is parallel to the light incident surface 150c may have a predetermined pitch P1. The pitch P1 may be defined as a distance between a center of prisms 153a and 153b arranged in a line along the second direction D2 (e.g., within a single first prism pattern area 500) and a center of prisms 153a and 153b arranged in another adjacent line along the second direction D2 (e.g., within a single second prism pattern area 500) may be in a range from about 350 μm to about 400 μm.

Referring to FIGS. 6 and 7, each prism 153c disposed at the prism pattern area 500, as representing the prisms 153a through 153b in FIG. 4 and FIG. 5, may be formed in a depressed engraved shape or an embossed shape, and may have a semicircular, semi-elliptical, circular or triangular cross-sectional shape. As being depressed, the prism 153c may extend into the body portion 151 from a lower surface thereof. As being embossed, the prism 153 may be protruded from the body portion 151 from the lower surface thereof, as shown in FIG. 7. The prisms 153c may define a portion of the lower surface 150b of the overall light guide plate 150, much like the lens pattern 152 may define a portion of or an entirety of the upper surface 150a of the light guide plate 150, without being limited thereto.

Each of the prisms 153c may have a predetermined width W1 in the first direction D1.

In an exemplary embodiment, for example, each of the prisms 153c may have a width W1 in a range from about 15 μm to about 25 um in the first direction D1.

The prisms 153c arranged along the first direction D1 which is perpendicular to the light incident surface 150c may be parallel to and adjacent to each other, but exemplary embodiments are not limited thereto. The prisms 153c arranged along the first direction D1 may be spaced apart from each other by a predetermined pitch. When the prisms 153c arranged along the first direction D1 are spaced apart from each other by a predetermined pitch, the pitches between adjacent ones of the prisms 153c arranged along the first direction D1 may be substantially equal to each other or may decrease in a direction from the light incident surface 150c toward the light opposing surface 150d.

First inclined surfaces 153c′ of the respective prisms 153c may be parallel to each other, and an angle θ1 between the first inclined surface 153c′ of each prism 153c and a plane common to each of the prisms 153c at the lower surface 150b of the light guide plate 150 may be in a range from about 45 degrees to about 55 degrees. The common plane may be a lower surface of the body portion 151, without being limited thereto. Alternatively, the first inclined surfaces 153c′ of the respective prisms 153c may not be parallel to each other. That is, the prisms 153c may each have the first inclined surfaces 153c′ having irregular shapes.

Second inclined surfaces 153c″ of the respective prisms 153c may be parallel to each other, and an angle θ2 between the second inclined surface 153c″ of each prism 153c and the plane common to each of the prism 153c at the lower surface 150b of the light guide plate 150 may be in a range from about 45 degrees to about 55 degrees. Alternatively, the second inclined surfaces 153c″ of the respective prisms 153c may not be parallel to each other. That is, the prisms 153c may each have the second inclined surfaces 153c″ having irregular shapes.

The angle θ1 between the first inclined surface 153c′ of each prism 153c and the plane common to each of the prism 153c at the lower surface 150b of the light guide plate 150 may be substantially equal to the angle θ2 between the second inclined surface 153c″ of each prism 153c and the plane common to each of the prism 153c at the lower surface 150b of the light guide plate 150.

A vertex at which the first inclined surface 153c′ and the second inclined surface 153c″ of each prism 153c meet may have a radius of curvature without being limited thereto.

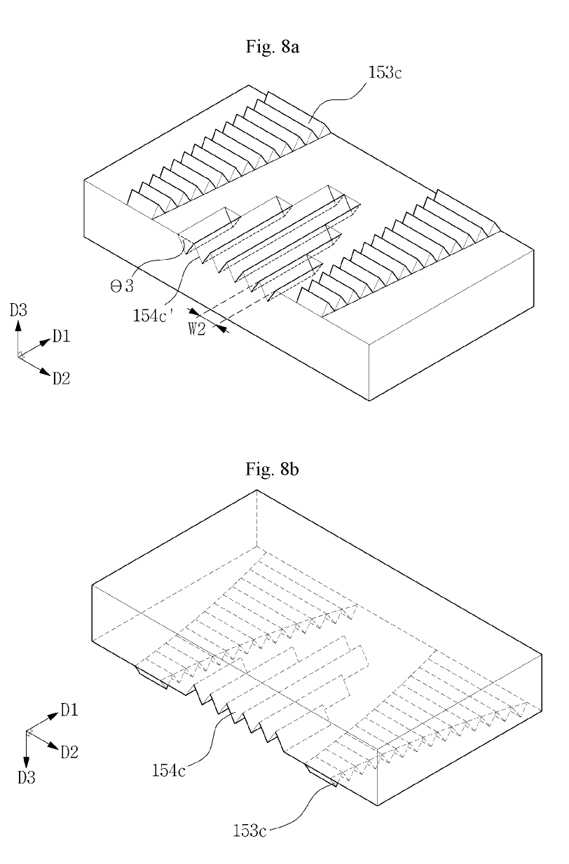

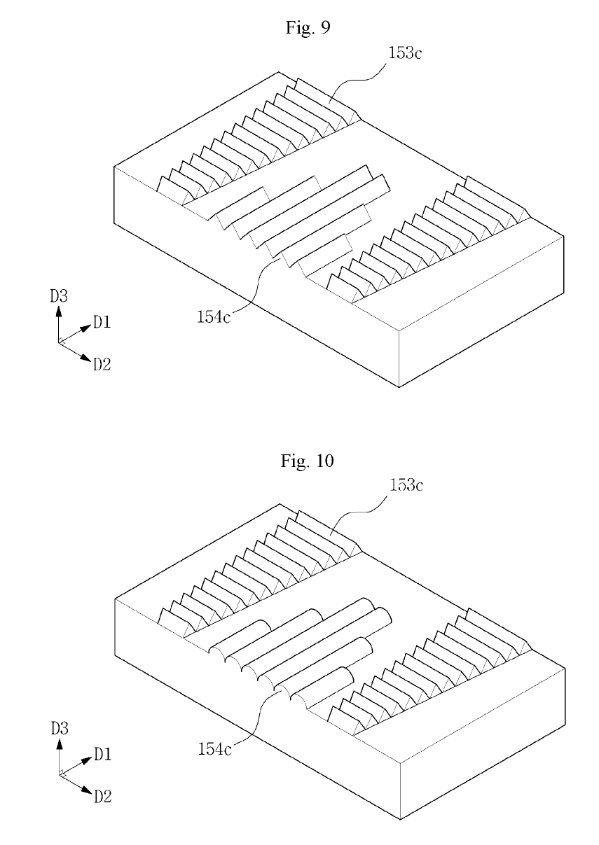

FIGS. 8a, 8b, 9, 10, 11, 12 and 13 are perspective views illustrating exemplary embodiment of shapes of the plurality of prisms and the plurality of linear patterns of the light guide plate according to the invention. For convenience of illustration, the opposing side surfaces of the light guide plate 150 along the first direction D1 in FIGS. 8a, 8b, 9, 10, 11, 12 and 13, may be the light incident surface 150c and the light opposing surface 150d disposed in order along the first direction D1, without being limited thereto. However, the opposing side surfaces of the light guide plate 150 along the second direction D2 in FIGS. 8a, 8b, 9, 10, 11, 12 and 13 may not be the end surfaces of the body portion 151. That is, in exemplary embodiments, the linear pattern area 510 may be the outermost pattern area of the lower surface 150b along the second direction D2, without being limited thereto.

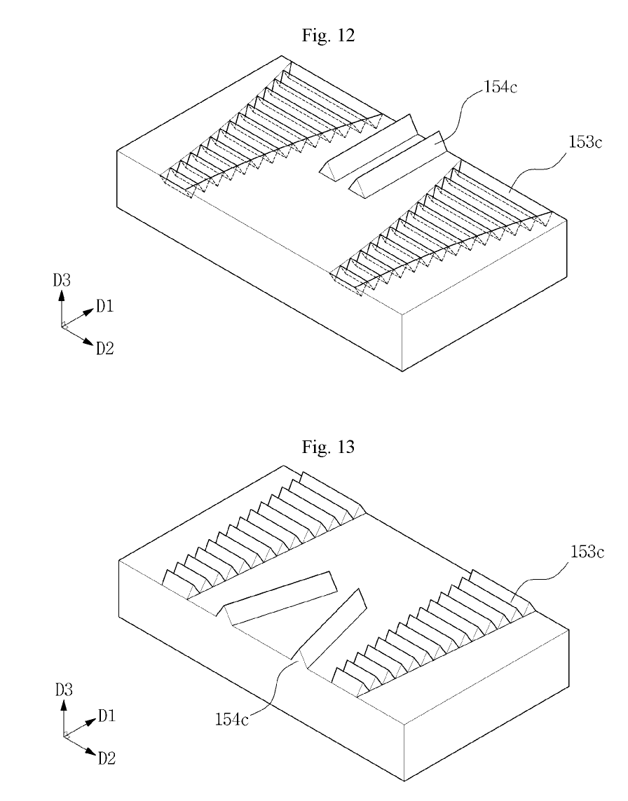

In FIGS. 8a, 8b, 9, 10, 11, 12 and 13, although the plurality of prisms and the plurality of linear patterns of the light guide plate are depicted as having a triangular cross-section, the invention is not limited thereto. The plurality of prisms and the plurality of linear patterns may have a semicircular, semi-elliptical, or circular cross-sectional shape in various exemplary embodiments. In addition, the plurality of prisms of the light guide plate may have an embossed shape as in FIGS. 8a, 8b, 9, 10, 11, and 13, or may have a depressed engraved shape as in FIG. 12. FIG. 8b indicates prisms and linear patterns at a lower surface of the light guide plate 150 viewed from an upper surface of the light guide plate of FIG. 8a.

Referring to FIGS. 8a and 8b, each of the linear patterns 154c has a length extending in the first direction D1 which is perpendicular to the light incident surface 150c. Lengths of the linear patterns 154c may increase as a distance along the second direction D2 to a center portion of the linear pattern area 510 decreases.

Each of the linear patterns 154c may have a predetermined width W2 in the second direction D2 which is parallel to the light incident surface 150c. In an exemplary embodiment, for example, each of the linear patterns 154c may have a width W2 in a range from about 5 μm to about 500 μm in the second direction D2. When the width W2 of the linear pattern 154c is less than about 5 μm, an effect of perpendicularly re-emitting the light leaked toward the side surface of the light guide plate 150 may be difficult to achieve. On the other hand, when the width W2 of the linear pattern 154c is more than about 500 μm, the patterns of the light guide plate 150 may be visually recognized on the display panel 120.

An angle θ3 between the first inclined surface 154c′ of each linear pattern 154c and a plane common to each of the linear patterns 154c at the lower surface 150b of the light guide plate 150 may be in a range from about 1 degree to about 80 degrees. As shown in FIGS. 8a and 8b, each of the prisms 153c and the linear patterns 154c extends from a common surface as the lower surface of the body portion 151 which is flat. Together, the prisms 153c, the linear patterns 154c and the (flat) lower surface of the body portion 151 define an entirety of the lower surface 150b of the light guide plate 150.

Referring to FIGS. 8a, 8b and 9, each of the linear patterns 154c may have a depressed engraved shape or an embossed shape. FIGS. 8a and 8b show the linear patterns 154c having an engraved shape (e.g., recessed from the lower surface of the body portion 151) while the prisms 153c have an embossed shape (e.g., protruded from the lower surface of the body portion 151). For a same arrangement as illustrated in FIGS. 8a and 8b, FIG. 9 shows each of the linear patterns 154c and the prisms 153c having an embossed shape (e.g., protruded from the lower surface of the body portion 151).

Referring to FIGS. 9 and 10, each of the linear patterns 154c may have a triangular (FIG. 9) or semicircular (FIG. 10) cross-sectional shape, but exemplary embodiments are not limited thereto. Each of the linear patterns 154c may have a semi-elliptical, circular or trapezoidal cross-sectional shape.

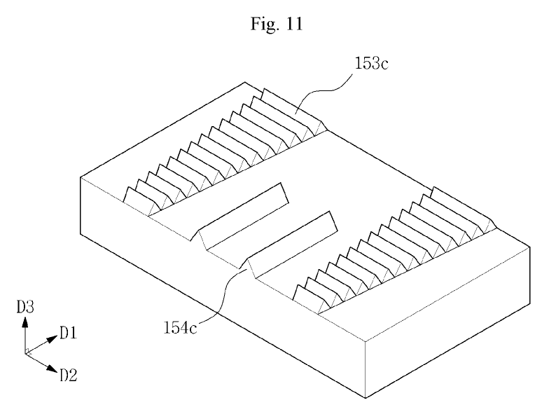

Referring to FIGS. 9 and 11, the plurality of linear patterns 154c may be adjacent to and parallel to each other (FIG. 9), or may be spaced apart from each other by a predetermined pitch (FIG. 11). In addition, the plurality of linear patterns 154c within a single linear pattern 154 at the linear pattern area 510 may each have a substantially equal length as each other (FIG. 11) or may have different lengths from each other (FIG. 9).

Referring to FIGS. 11 and 12, each of the linear patterns 154c starts from the light incident surface 150c (FIG. 11) and extends toward the light opposing surface 150d, or starts from the light opposing surface 150d (FIG. 12) and extends toward the light incident surface 150c. That is, ends of the linear patterns 154c may be coplanar or aligned with a side surface (150c or 150d) of the light guide plate 150, or may be coplanar or aligned with both of opposing side surfaces (150c and 150d) of the light guide plate 150. Where first ends of the linear patterns 154c may be aligned with a particular side surface (150c or 150d) of the light guide plate 150, second ends of the linear patterns 154c opposite to the first ends thereof may be spaced apart from the opposing side surface (150d or 150d) along the first direction D1.

Referring to FIG. 13, the plurality of linear patterns 154c may be spaced apart from each other in an alternate manner. As being disposed in an alternate manner, a first linear pattern forms a first angle with respect to the light incident surface 150c of the light guide plate 150, and a second linear pattern adjacent to the first linear pattern forms a second angle with respect to the light incident surface 150c of the light guide plate 150 which is different from the first angle. The first linear pattern forming the first angle alternates in the second direction with the second linear pattern forming the second angle. In an exemplary embodiment, for example, the plurality of linear patterns 154c may be arranged at an angle in a range from about 0 degrees to about 60 degrees with respect to each other instead of being parallel to each other.

As set forth hereinabove, the backlight unit and the display device according to one or more exemplary embodiments may have high luminous efficiency by improving light incident to the light guide plate from the light source that leaks toward a side surface without being emitted perpendicularly.

The backlight unit and the display device according to one or more exemplary embodiments may achieve a slimmer display device and reduce manufacturing costs by omitting an optical sheet.

While the invention has been illustrated and described with reference to the exemplary embodiments thereof, it will be apparent to those of ordinary skill in the art that various changes in form and detail may be formed thereto without departing from the spirit and scope of the invention.

What is claimed is:

1. A backlight unit comprising:
a light source which generates light used by a display panel to display an image; and
a light guide plate which guides the light from the light source towards the display panel, the light guide plate comprising:
an upper surface facing the display panel,
a lower surface opposing the upper surface, comprising:
a prism pattern area provided in plurality, and
a linear pattern area provided between prism pattern areas, and
a light incident surface facing the light source,
wherein
the prism pattern area comprises a prism provided in plurality arranged along a first direction perpendicular to the light incident surface,
the linear pattern area comprises a linear pattern provided in plurality arranged along a second direction parallel to the light incident surface, and
within the prism pattern area,
a length of each of the prisms extends in the second direction parallel to the light incident surface, and
lengths of the prisms increase as a distance along the first direction from the light incident surface increases.

2. The backlight unit of claim 1, wherein within the linear pattern area between prism pattern areas, each of the linear patterns has at least one of triangular, semicircular, semi-elliptical, circular and trapezoidal cross-sectional shape.

3. The backlight unit of claim 1, wherein
the light guide plate further comprises a body portion having a lower surface common to each of the prisms and the linear patterns, and
within the linear pattern area between prism pattern areas, each of the linear patterns has at least one of an embossed shape protruded from the lower surface of the body portion and a depressed engraved shape recessed from the lower surface of the body portion.

4. The backlight unit of claim 1, wherein for each of the plurality of linear patterns within the linear pattern area between prism pattern areas:
a length thereof extends in the first direction perpendicular to the light incident surface and a width thereof extends in the second direction parallel to the light incident surface, and
the width of each of the linear patterns is in a range from about 5 micrometers to about 500 micrometers.

5. The backlight unit of claim 1, wherein
the light guide plate further comprises a body portion having a lower surface common to each of the prisms and the linear patterns, and
within the linear pattern area between prism pattern areas, in cross-section, each of the plurality of linear patterns includes a first inclined surface which forms an angle in a range from about 1 degree to about 80 degrees with respect to the lower surface of the body portion.

6. The backlight unit of claim 1, wherein within the linear pattern area between prism pattern areas, the plurality of linear patterns are disposed directly adjacent to each other along the second direction and parallel to each other.

7. The backlight unit of claim 1, wherein within the linear pattern area between prism pattern areas, the plurality of linear patterns are spaced apart from each other along the second direction.

8. The backlight unit of claim 1, wherein in a plane defined by the first and second directions, within the linear pattern area between prism pattern areas, linear patterns adjacent to each other are arranged at an angle in a range from about 0 degrees to about 60 degrees with respect to each other.

9. The backlight unit of claim 1, wherein within the linear pattern area between prism pattern areas, a length of each the plurality of linear patterns extends in the first direction perpendicular to the light incident surface.

10. The backlight unit of claim 1, wherein within the linear pattern area between prism pattern areas, the linear patterns have lengths equal to each other.

11. The backlight unit of claim 1, wherein within the linear pattern area between prism pattern areas, the linear patterns have different lengths from each other.

12. The backlight unit of claim 1, wherein within the linear pattern area between prism pattern areas, lengths of the plurality of linear patterns increase as a distance from a center portion of the linear pattern area along the second direction decreases.

13. The backlight unit of claim 1, wherein within the linear pattern area between prism pattern areas,
a length of each the plurality of linear patterns extends in the first direction perpendicular to the light incident surface, and
ends of each of the linear patterns of which the length thereof extends in the first direction is aligned with the light incident surface.

14. The backlight unit of claim 1, wherein
the light guide plate further comprises a light opposing surface opposing the light incident surface along the first direction perpendicular to the light incident surface, and
within the linear pattern area between prism pattern areas,
a length of each the plurality of linear patterns extends in the first direction perpendicular to the light incident surface, and
ends of each of the linear patterns portions of which the length thereof extends in the first direction is aligned with the light opposing surface.

15. The backlight unit of claim 1, wherein within the prism pattern area, the plurality of prisms are disposed directly adjacent to each other in the second direction and parallel to each other.

16. The backlight unit of claim 1, wherein
the light guide plate further comprises a body portion having a lower surface common to each of the prisms and the linear patterns, and
within the prism pattern area, each of the prisms has at least one of an embossed shape protruded from the lower surface of the body portion and a depressed engraved shape recessed from the lower surface of the body portion.

17. The backlight unit of claim 1, wherein
the light guide plate further comprises a body portion having a lower surface common to each of the prisms and the linear patterns, and
within the prism pattern area, in cross-section, each of the plurality of prisms includes a first inclined surface and a second inclined surface respectively forming an angle with respect to the lower surface of the body portion, the angles within each of the prisms being equal to each other.

18. The backlight unit of claim 1, wherein the upper surface of the light guide plate which faces the display panel further comprises a lens pattern provided in plurality.

19. A display device comprising:
a display panel which displays an image with light;
a light source which generates the light; and
a light guide plate which guides the light from the light source towards the display panel, the light guide plate comprising:
an upper surface facing the display panel,
a lower surface opposing the upper surface, comprising:
a prism pattern area provided in plurality, and
a linear pattern area provided between prism pattern areas, and
a light incident surface facing the light source,
wherein
the prism pattern area comprises a prism provided in plurality arranged along a first direction perpendicular to the light incident surface,
the linear pattern area comprises a linear pattern provided in plurality arranged along a second direction parallel to the light incident surface,
within the prism pattern area,
a length of each of the prisms extends in the second direction parallel to the light incident surface, and
lengths of each of the prisms increase as a distance along the first direction from the light incident surface increases,
within the linear pattern area between prism pattern areas, the plurality of linear patterns are spaced apart from each other along the second direction, and
within a plane defined by the first and second directions, each of adjacent linear patterns spaced apart from each other is disposed inclined with respect to the light incident surface of the light guide plate.

20. The display device of claim 19, wherein within the linear pattern area between prism pattern areas, among the adjacent linear patterns spaced apart from each other,
with respect to the light incident surface of the light guide plate, a first linear pattern forms a first angle and a second linear pattern forms a second angle,
the first linear pattern forming the first angle alternates in the second direction with the second linear pattern forming the second angle, and
the first and second linear patterns form an angle in a range from about 0 degrees to about 60 degrees with respect to each other.
